(19) United States
(12) Patent Application Publication
(10) Pub. No.: US 2026/0056373 A1
(43) Pub. Date: Feb. 26, 2026

(54) OPTICAL CONNECTION COMPONENT AND OPTICAL CONNECTION METHOD

(71) Applicants: SUMITOMO ELECTRIC INDUSTRIES, LTD., Osaka-shi, Osaka (JP); Sumitomo Electric Optifrontier Co., Ltd., Yokohama-shi, Kanagawa (JP); Nippon Tsushin Denzai Co., Ltd., Komaki-shi, Aichi (JP)

(72) Inventors: Shunichi WATANABE, Osaka-shi (JP); Yasuyuki MAEKAWA, Yokohama-shi (JP); Masaki OMURA, Osaka-shi (JP); Daichi YAMADA, Komaki-shi (JP); Motoyoshi KIMURA, Komaki-shi (JP); Takayuki YOKOCHI, Osaka-shi (JP)

(73) Assignees: SUMITOMO ELECTRIC INDUSTRIES, LTD., Osaka-shi, Osaka (JP); Sumitomo Electric Optifrontier Co., Ltd., Yokohama-shi, Kanagawa (JP); Nippon Tsushin Denzai Co., Ltd., Komaki-shi, Aichi (JP)

(21) Appl. No.: 19/105,379

(22) PCT Filed: Sep. 7, 2022
(86) PCT No.: PCT/JP2022/033617

§ 371 Date: Feb. 21, 2025

(51) Int. Cl. G02B 6/38; G02B 6/36

(52) U.S. Cl. CPC G02B 6/389; G02B 6/3616; G02B 6/3632; G02B 6/3879

(57) ABSTRACT

An optical connection component according to one embodiment comprises: an adapter to which an optical connector that has a ferrule holding an optical fiber is connected; and a lever member which is attached to the adapter rotatably about a central axis that extends along a first direction intersecting with the optical axis direction of the optical fiber. The adapter has a latch with which the optical connector that moves along the optical axis direction engages. The lever member has a movement mechanism which rotates about the central axis toward the optical connector so as to cause the optical connector to move along the optical axis direction.

### TECHNICAL FIELD

The present disclosure relates to an optical connection component and an optical connection method.

### BACKGROUND ART

Patent literature 1 describes an optical connection component that optically connects a pair of fiber optic connectors via an adapter. The fiber optic connector includes an inner connector body that houses a first ferrule and a second ferrule, and a rear connector body connected to the inner connector body. Each of the first ferrule and second ferrule holds an optical fiber. The rear connector body has a handle extending in the direction opposite to the inner connector body. The inner connector body has a latch arm extending in the optical axis direction of the optical fiber. The adapter has a groove with which the latch arm engages.

Patent literature 2 describes an optical connector. The optical connector includes an optical receptacle and an optical plug to be inserted into the optical receptacle. The optical plug has an engaging section that engages with the optical receptacle. The engaging section includes an engagement piece that hooks the optical receptacle and a protruding portion which enters into a hole formed in the optical receptacle.

Patent literature 3 describes an adapter assembly. The adapter assembly includes an adapter, a plug inserted into the adapter, and a ferrule holder functioning as a fiber optic connector inserted into the plug. The ferrule holder houses a plurality of ferrules for holding optical fibers. The ferrule holder has a latch extending obliquely upward from the top surface. The ferrule holder is attached to the plug by the latch engaging with the plug.

Patent literature 4 describes a connector assembly. The connector assembly has a first connector part and a second connector part connected to each other along a connection direction. The first connector part has a base and a lever attached to the base so as to be rotatable. The lever rotates on a rotation axis extending in a direction orthogonal to the connection direction. The second connector part is connected to the first connector part by rotating the lever.

Patent literature 5 describes an adapter retention mechanism. In the adapter retention mechanism, a first optical fiber group and a second optical fiber group are connected to each other via an adapter. The adapter retention mechanism further includes four closure members covering each of the first optical fiber group and the second optical fiber group. Two of the four closure members hold the first optical fiber group, and the other two hold the second optical fiber group. Each closure member is pivotably attached to the adapter. Each closure member covers the first optical fiber group or the second optical fiber group, thereby realizing optical connection between the first optical fiber group and the second optical fiber group.

Patent literature 6 describes a connection structure of an optical connector. This connection structure has a plug receptacle having a port and a plug connector to be inserted into the port. The connection structure further includes a release member that enables removal of the plug connector from the port.

### CITATION LIST

### Patent Literature

Patent literature 1: U.S. Patent Application Publication No. 2017/0227720
Patent literature 2: U.S. Patent Application Publication No. 2020/0257064
Patent literature 3: U.S. Patent Application Publication No. 2021/0255403
Patent literature 4: U.S. Patent Application Publication No. 2020/0006893
Patent literature 5: U.S. Patent Application Publication No. 2019/0331862
Patent literature 6: WO 2022/036119

### SUMMARY

An optical connection component according to the present disclosure includes an adapter to which an optical connector including a ferrule holding an optical fiber is connected, and a lever member attached to the adapter so as to be rotatable about a central axis extending in a first direction intersecting an optical axis direction of the optical fiber. The adapter has a latch with which the optical connector transferring in the optical axis direction engages. The lever member has a transfer mechanism configured to transfer the optical connector in the optical axis direction by rotating about the central axis toward the optical connector.

An optical connection method according to the present disclosure is an optical connection method of optically connecting an optical connector including an optical fiber to a mating connector via an adapter, and the method includes including a lever member attached to the adapter so as to be rotatable about a central axis extending in a first direction intersecting an optical axis direction of the optical fiber, and, by rotating the lever member about the central axis toward the optical connector, transferring the optical connector in the optical axis direction and engaging the optical connector with a latch of the adapter.

### BRIEF DESCRIPTION OF THE DRAWINGS

FIG. 1 is a cross-sectional view showing an optical connection component according to an embodiment.

FIG. 2 is a perspective view showing the optical connection component according to an embodiment.

FIG. 3 is an exploded perspective view showing an optical connector of the optical connection component according to an embodiment.

FIG. 4 is a side view showing the optical connector of FIG. 3.

FIG. 5 is a front view showing the optical connector of FIG. 3.

FIG. 6 is a perspective view showing an adapter of the optical connection component according to an embodiment.

FIG. 7 is a cross-sectional view showing the adapter of FIG. 6.

FIG. 8 is a perspective view showing a lever member of the optical connection component according to an embodiment.

FIG. 9 is a cross-sectional view showing the lever member of FIG. 8.

FIG. 10 is a diagram showing one step of an optical connection method according to an embodiment.

FIG. 11 is a diagram showing one step of the optical connection method according to an embodiment.

FIG. 12 is a diagram showing one step of the optical connection method according to an embodiment.

FIG. 13 is a diagram showing one step of the optical connection method according to an embodiment.

FIG. 14 is a cross-sectional view showing one step of the optical connection method according to an embodiment.

### DETAILED DESCRIPTION

In the optical connection component and the optical connection method, a plurality of optical fibers held by each of a plurality of ferrules sometimes have to be connected by physical contact (PC). However, when the number of optical fibers or the number of ferrules of the optical connector is large, the increase in the fitting load of the optical connector may make it difficult to perform PC connection of all the optical fibers. When ultra multi-core optical fibers are PC-connected, it may be difficult to manually insert the optical connector and connect the optical connector.

The present disclosure aims to provide an optical connection component and an optical connection method that can easily connect an optical connector.

### Description of Embodiments of Present Disclosure

First, embodiments of the present disclosure will be listed and described.
(1) An optical connection component according to an embodiment includes an adapter to which an optical connector including a ferrule holding an optical fiber is connected, and a lever member attached to the adapter so as to be rotatable about a central axis extending in a first direction intersecting an optical axis direction of the optical fiber. The adapter has a latch with which the optical connector transferring in the optical axis direction engages. The lever member has a transfer mechanism configured to transfer the optical connector in the optical axis direction by rotating about the central axis toward the optical connector.

In this optical connection component, the optical connector has the ferrule holding the optical fiber, and the optical connector is connected to the adapter. The adapter has the transfer mechanism configured to transfer the optical connector in the optical axis direction. Since the adapter, instead of the optical connector, has the transfer mechanism, the optical connector can be miniaturized and the optical connector can be easily inserted into the adapter. The optical connection component includes the lever member attached to the adapter so as to be rotatable. The lever member has the transfer mechanism configured to transfer the optical connector in the optical axis direction by rotating toward the optical connector. Thus, the optical connector can be transferred in the optical axis direction by the rotation of the lever member, and the optical connector can be engaged with the latch. Thus, the optical connector can be easily connected.
(2) In the above (1), the lever member may have a latch pressing member configured to press the latch with the optical connector engaged. In this case, the latch pressing member presses the latch of the adapter, and thus the opening of the latch with the optical connector engaged can be suppressed. Thus, the optical connector can be firmly engaged with the latch of the adapter.
(3) In the above (1) or (2), the transfer mechanism may have a projecting portion configured to transfer the optical connector in the optical axis direction in a state of being in contact with the optical connector. In this case, the transfer mechanism has the projecting portion, and thus the configuration of the transfer mechanism for transferring the optical connector can be simplified. The optical connector can be pushed toward the adapter by the lever member rotating in a state in which the projecting portion is in contact with the optical connector. Thus, the lever member is rotated, and the optical connector can be pushed toward the adapter by the projecting portion, so that the optical connector can be easily connected to the adapter.
(4) In the above (3), the optical connector may have a protruding portion protruding in a direction opposite to a direction in which the transfer mechanism transfers the optical connector. The transfer mechanism may transfer the optical connector by the lever member rotating in a state in which the projecting portion is in contact with the protruding portion. In this case, the optical connector can be transferred by the lever member rotating in a state in which the projecting portion is in contact with the protruding portion of the optical connector.
(5) In any one of the above (1) to (4), the optical connector may include a plurality of the ferrules, and a housing unit housing the plurality of ferrules. In this case, the housing unit houses a plurality of ferrules, and thus the plurality of ferrules of the optical connector can be collectively optically connected.
(6) In the above (5), in the housing unit, the plurality of ferrules may be arranged in the first direction, and may be arranged in a second direction intersecting both the optical axis direction and the first direction. In this case, a plurality of ferrules arranged in the first direction and the second direction can be optically connected at once.
(7) In the above (6), each of the plurality of ferrules may have an end surface that faces a mating connector to which the optical connector is optically connected via the adapter. The plurality of ferrules may be disposed so that a plurality of the end surfaces are arranged on a virtual inclined surface inclined with respect to the second direction when viewed in the first direction. In this case, since each of the plurality of end surfaces is inclined with respect to the second direction, it is possible to suppress the reflected return light from each end surface. The plurality of ferrules are disposed so that the plurality of end surfaces are arranged on a virtual inclined surface inclined with respect to the second direction. Thus, a cleaning tool can be moved along the plurality of end surfaces to clean the plurality of end surfaces, and thus the end surfaces of the ferrules can be easily cleaned.
(8) In any one of the above (5) to (7), the housing unit may include a front housing having a recessed portion with which the latch engages. In this case, the latch of the adapter can be engaged with the recessed portion formed in the front housing of the optical connector.
(9) In the above (8), the front housing may have a rectangular parallelepiped shape. In this case, the front housing can be formed in a simple shape, which contributes to further miniaturization of the optical connector.
(10) In the above (8) or (9), the ferrule may be housed in the front housing.
(11) In any one of the above (5) to (10), the housing unit may include a middle housing including a space forming portion forming a space through which the optical fiber held by the ferrule passes. In this case, the optical fiber extending from the ferrule can be passed through the space formed by the space forming portion of the middle housing.
(12) In the above (11), the optical connector may include a spring member interposed between the ferrule and the middle housing.

In this case, the ferrule can be biased by the spring member.
(13) In the above (11) or (12), the housing unit may include a rear housing housing the middle housing.
(14) In any one of the above (1) to (13), the lever member may have a plurality of the transfer mechanisms arranged in the first direction. In this case, the plurality of transfer mechanisms transfer the optical connector in the optical axis direction. Thus, since the optical connector can be transferred more smoothly, the optical connector can be connected to the adapter more easily.
(15) In the above (3) or (4), the optical connector may pass over the projecting portion when engaging with the latch as a result of rotation of the lever member. The transfer mechanism may have a retraction portion into which the optical connector having passed over the projecting portion enters. In this case, the optical connector that has passed over the projecting portion can be retracted to the retraction portion.
(16) In any one of the above (1) to (15), the adapter may have a protrusion protruding in the first direction or a hole depressed in the first direction. The lever member may have the hole or the protrusion. The lever member may be rotatable with respect to the adapter in a state in which the protrusion is fitted into the hole. In this case, an attachment structure of the lever member to the adapter can be simplified.
(17) In any one of the above (1) to (16), the adapter may have a pair of first wall portions arranged in the first direction. The lever member may have a pair of second wall portions arranged in the first direction. The lever member may be attached to the adapter in a state in which the second wall portions are positioned on both end sides in the first direction with respect to the first wall portions. In this case, the second wall portion of the lever member is positioned on both end sides in the first direction with respect to the first wall portion of the adapter. Thus, since the lever member is disposed so as to sandwich the adapter from the first direction, the rotation of the lever member with respect to the adapter can be stabilized. Thus, the optical connector can be connected to the adapter more easily.
(18) In the above (17), the adapter may have protrusions protruding from the first wall portions toward both the end sides in the first direction. The lever member may have holes into which the protrusions are inserted. The lever member may be rotatable with respect to the adapter in a state in which the protrusions are fitted into the holes. In this case, since the lever member is attached to the adapter so as to be rotatable by fitting the protrusion into the hole, the attachment structure of the lever member to the adapter can be further simplified.
(19) In the above (18), the lever member may have an upper surface portion connecting the pair of second wall portions to each other. In this case, the lever member can be rotated toward the optical connector by pushing the upper surface portion, and thus the optical connector can be more easily connected to the adapter.
(20) In any one of the above (1) to (19), the adapter may include a lever opening prevention portion located on each of both end sides in the first direction of the lever member. In this case, the lever opening prevention portion can prevent the lever member from opening.
(21) An optical connection method according to an embodiment is an optical connection method of optically connecting an optical connector including an optical fiber to a mating connector via an adapter, and the method includes including a lever member attached to the adapter so as to be rotatable about a central axis extending in a first direction intersecting an optical axis direction of the optical fiber, and, by rotating the lever member about the central axis toward the optical connector, transferring the optical connector in the optical axis direction and engaging the optical connector with a latch of the adapter.

In this optical connection method, the optical connector is connected to the adapter, and the adapter has a transfer mechanism transferring the optical connector in an optical axis direction. Since the adapter, instead of the optical connector, has the transfer mechanism, the optical connector can be miniaturized and the optical connector can be easily inserted into the adapter. In the optical connection method, the optical connector can be transferred in the optical axis direction by rotating the lever member attached to the adapter so as to be rotatable. Thus, since the optical connector can be transferred in the optical axis direction by the rotation of the lever member to engage the optical connector with the latch, the optical connector can be easily connected.

### Details of Embodiments of Present Disclosure

Specific examples of an optical connection component and an optical connection method according to an embodiment will be described below with reference to the drawings. The present invention is not limited to the following examples, but is intended to include all modifications within the scope of the claims and equivalents thereof. In the description of the drawings, the same or corresponding elements are denoted by the same reference numerals, and redundant description thereof will be appropriately omitted. In the drawings, some components may be simplified or exaggerated for easy understanding, and the dimensional ratios and the like are not limited to those shown in the drawings.

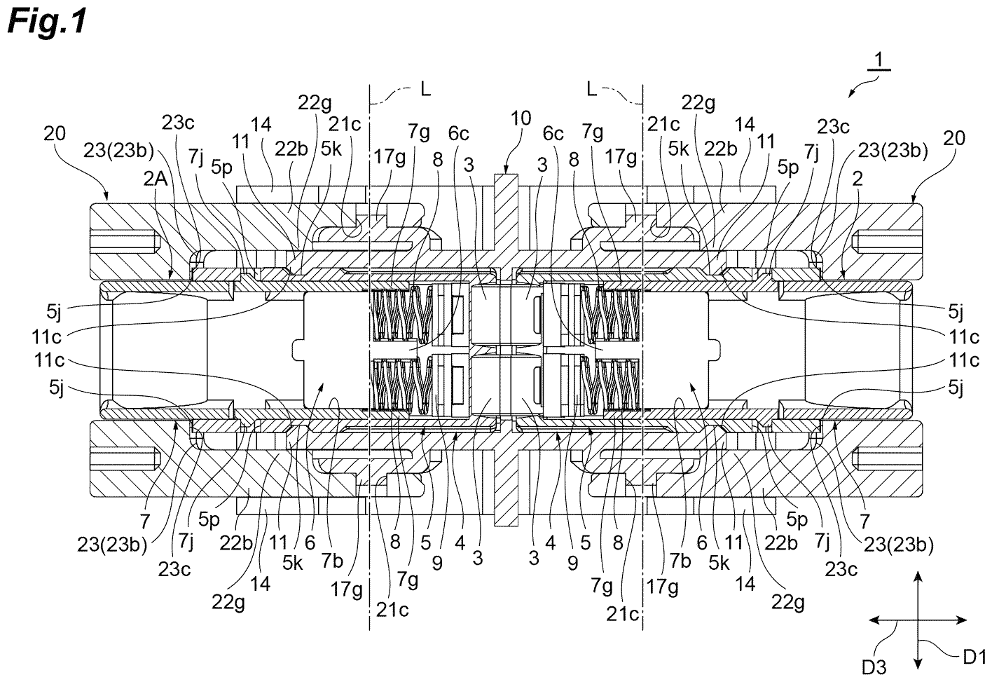

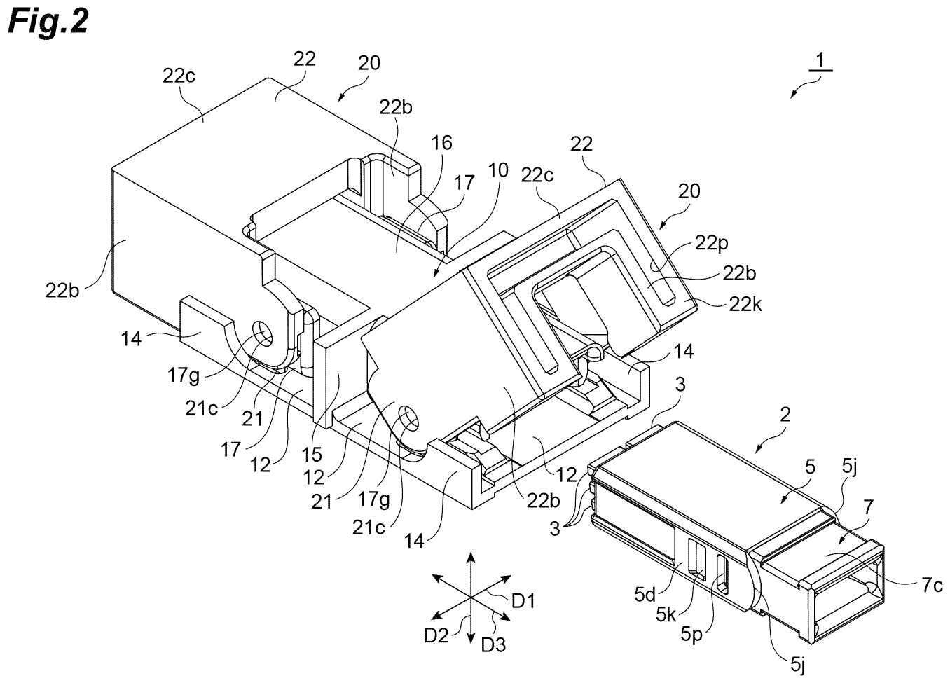

FIG. 1 is a cross-sectional view showing an optical connection component 1 as an example. FIG. 2 is a perspective view showing optical connection component 1. As shown in FIGS. 1 and 2, optical connection component 1 includes an adapter 10 to which an optical connector 2 is connected, and a lever member 20 attached to adapter 10 so as to be rotatable. Optical connector 2 and a mating connector 2A are connected to adapter 10. A material of components constituting each of optical connection component 1 and optical connector 2 may be, for example, a resin material such as polycarbonate (PC), polyetherimide (PEI), polyamide (PA), polyacetal (POM), polyphenylene ether (PPE), polybutylene terephthalate (PBT), polyphenylene sulfide (PPS), or polyethersulfone (PES), or a composite material in which glass fibers or glass spheres are filled in a resin material.

Optical connector 2 is connected to adapter 10 to be connected to mating connector 2A. The configuration of mating connector 2A may be different from the configuration of optical connector 2. However, in the following, an example in which the configuration of mating connector 2A is the same as the configuration of optical connector 2 will be described, and the description of the configuration of mating connector 2A will be appropriately omitted.

Optical connection component 1 includes, for example, one adapter 10 and two lever members 20. Lever members 20 are attached to adapter 10 so as to be rotatable about a central axis L extending in a first direction D1 which is a width direction of adapter 10. Lever members 20 transfer in a second direction D2 intersecting first direction D1 with respect to optical connector 2 to connect optical connector 2 to adapter 10. Second direction D2 is, for example, a direction orthogonal to first direction D1.

In optical connection component 1, two lever members 20 are arranged in a direction D3. Direction D3 is a direction intersecting (for example, orthogonal to) both first direction D1 and second direction D2. Optical connector 2 has, for example, a rectangular parallelepiped shape. Optical connector 2 is connected to adapter 10 so as to be arranged to adapter 10 in direction D3. Direction D3 corresponds to a connection direction of optical connector 2 to adapter 10. Lever member 20 is provided to come into contact with optical connector 2 and push optical connector 2 into the center of adapter 10 in direction D3. Hereinafter, a direction in which optical connector 2 is pushed may be referred to as front, front side, or forward, and a direction opposite to the direction in which optical connector 2 is pushed may be referred to as rear, rear side, or rearward.

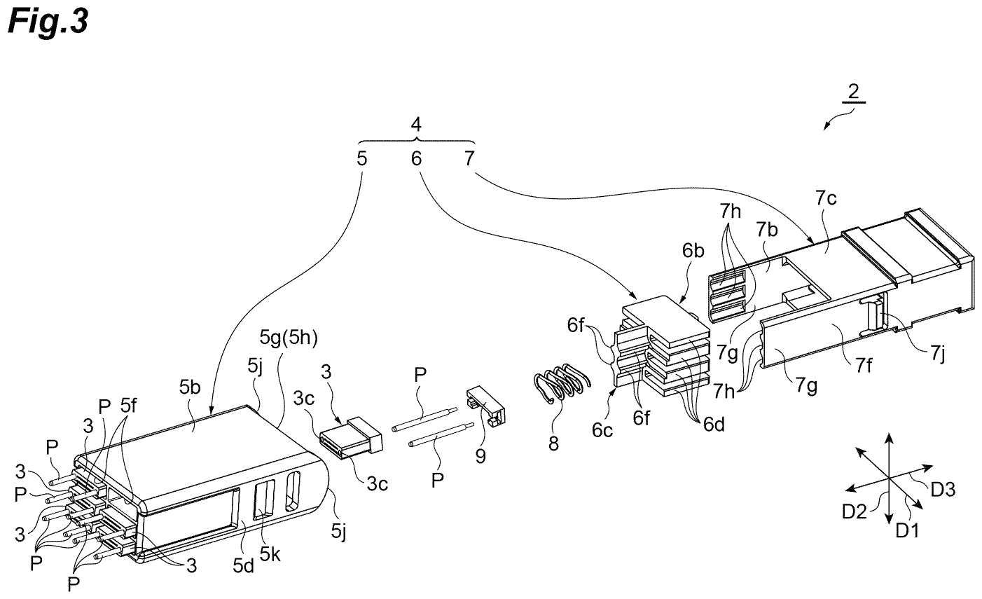

FIG. 3 is an exploded perspective view showing optical connector 2. As shown in FIGS. 1 and 3, optical connector 2 has, for example, a ferrule 3 and a housing unit 4 housing ferrule 3. Housing unit 4 includes, for example, a front housing 5, a middle housing 6, and a rear housing 7. Optical connector 2 includes a spring member 8 for biasing ferrule 3 and a pin keeper 9 for holding a guiding pin P inserted into ferrule 3.

Optical connector 2 includes, for example, a plurality of ferrules 3 housed in housing unit 4. In housing unit 4, the plurality of ferrules 3 are arranged in first direction D1 and are arranged in second direction D2. For example, two ferrules 3 are arranged in first direction D1, and three ferrules 3 are arranged in second direction D2.

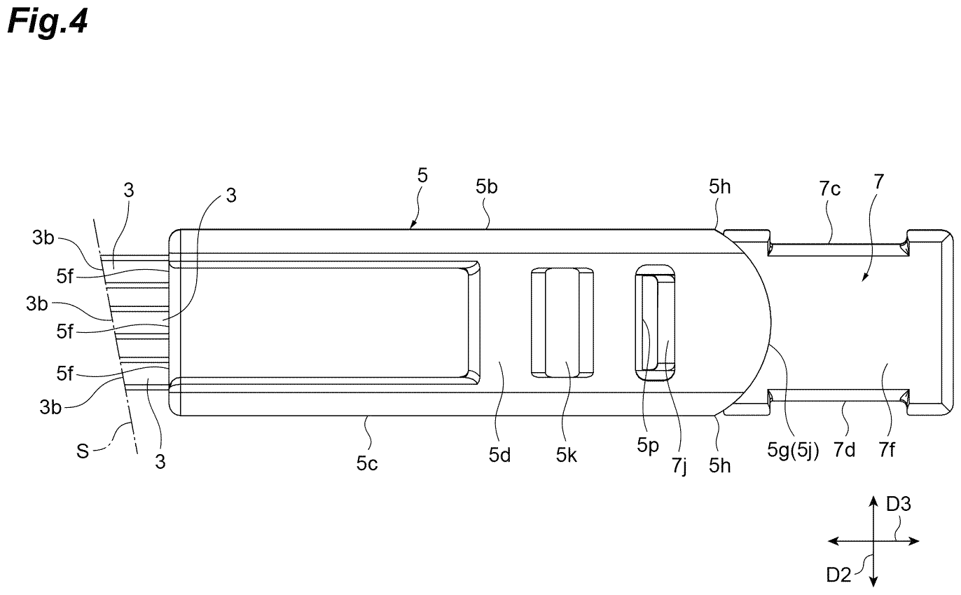

FIG. 4 is a side view showing optical connector 2 as viewed in first direction D1. As shown in FIGS. 3 and 4, each ferrule 3 has an end surface 3b facing mating connector 2A. The plurality of ferrule 3 are disposed so that the plurality of end surfaces 3b are arranged on a virtual inclined surface S when viewed in first direction D1. Inclined surface S is a surface extending in first direction D1 and inclined with respect to second direction D2. For example, the inclined angle of inclined surface S with respect to second direction D2 is 8 degrees.

Ferrule 3 has a guiding hole 3c through which guiding pin P is inserted. Guiding hole 3c passes through ferrule 3 in direction D3. Two guiding holes 3c are arranged in first direction D1. Guiding pin P inserted into guiding hole 3c protrudes from end surface 3b. Guiding pin P is inserted into, for example, guiding hole 3c of ferrule 3 of mating connector 2A.

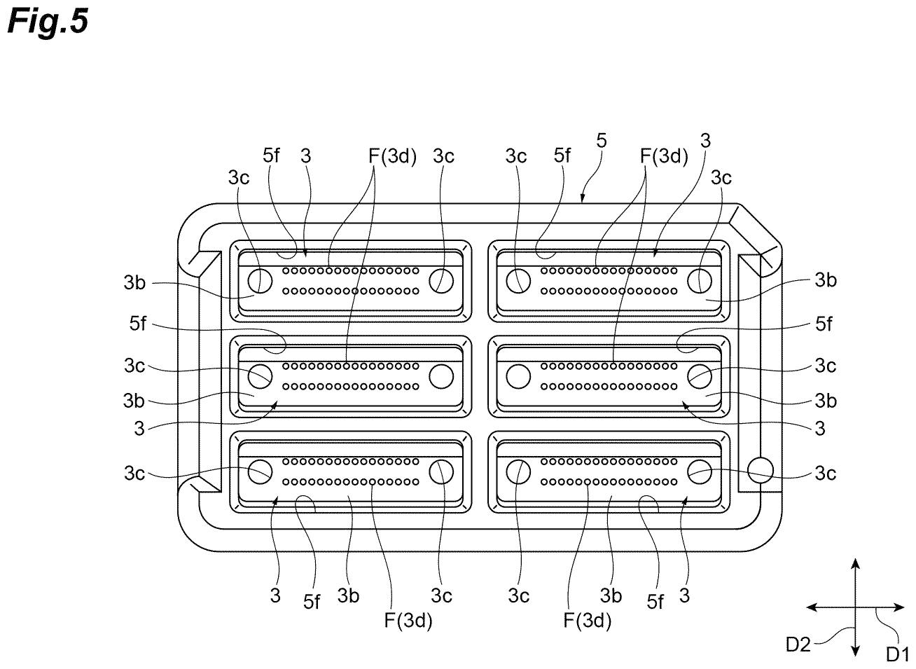

FIG. 5 is a front view showing optical connector 2 as viewed in first direction D1. As shown in FIG. 5, optical connector 2 has an optical fiber F held by ferrule 3. Optical fiber F extends from end surface 3b of ferrule 3 in direction D3. Direction D3 corresponds to an optical axis direction of optical fiber F. For simplifying the drawings, optical fiber F is not shown in the drawings other than FIG. 5.

Ferrule 3 has a plurality of optical fiber holding holes 3d holding optical fibers F, and each optical fiber holding hole 3d passes through ferrule 3 in direction D3. The plurality of optical fiber holding holes 3d are formed between the pair of guiding holes 3c on end surface 3b. On end surface 3b, the plurality of optical fiber holding holes 3d are arranged in first direction D1 and are arranged in second direction D2. For example, ferrule 3 has 32 optical fiber holding holes 3d. In this case, the number of cores of optical connector 2 (the number of optical fibers F) is 192. For example, on end surface 3b, 2 optical fiber holding holes 3d are arranged in second direction D2, and 16 optical fiber holding holes 3d are arranged in first direction D1.

As shown in FIGS. 3 and 4, front housing 5 has a rectangular parallelepiped shape. For example, the length of front housing 5 in direction D3 is longer than the length of front housing 5 in first direction D1, and the length of front housing 5 in first direction D1 is longer than the length of front housing 5 in second direction D2. Front housing 5 has, for example, an upper surface portion 5b, a lower surface portion 5c, and a pair of side surface portions 5d. Upper surface portion 5b extends in both first direction D1 and direction D3, and lower surface portion 5c faces opposite to upper surface portion 5b. The pair of side surface portions 5d faces first direction D1 and is arranged in first direction D1.

Ferrule 3 is housed in front housing 5. Front housing 5 has a first opening 5f from which ferrule 3 is exposed and a second opening 5g into which middle housing 6 and rear housing 7 are inserted. First opening 5f faces forward, and second opening 5g faces rearward. Ferrule 3 protrudes from first opening 5f. For example, a plurality of guiding pins P protrude from first opening 5f. In FIG. 4, guiding pin P is not shown. Second opening 5g is defined by an end edge 5h extending in first direction D1 at one end of front housing 5 in direction D3 and a protruding portion 5j protruding backward in side surface portion 5d. For example, front housing 5 includes a pair of end edges 5h arranged in second direction D2 and a pair of protruding portions 5j arranged in first direction D1. Protruding portion 5j is curved so as to protrude backward as it approaches the center of protruding portion 5j in second direction D2, for example. As an example, protruding portion 5j is formed in an arc shape. In this case, the radius of protruding portion 5j is smaller than the radius of rotation of lever member 20, which will be described later.

As shown in FIGS. 1, 3 and 4, front housing 5 has a recessed portion 5k to be engaged with a latch 11 of adapter 10 described later. Recessed portion 5k is formed in each of the pair of side surface portions 5d arranged in first direction D1. For example, recessed portion 5k has a rectangular shape when viewed in first direction D1. For example, the cross-sectional surface shape of recessed portion 5k when cut along a plane extending in both first direction D1 and direction D3 has a trapezoidal shape. Latch 11 of adapter 10 is engaged with recessed portion 5k, and thus optical connector 2 is connected to adapter 10.

Front housing 5 has an engagement hole 5p to be engaged with rear housing 7. Front housing 5 has engagement hole 5p in each of the pair of side surface portions 5d. Engagement hole 5p has, for example, an oval shape extending in second direction D2. Rear housing 7 is engaged with engagement hole 5p from the inner side of front housing 5. Thus, rear housing 7 is mounted on front housing 5.

Middle housing 6 includes a space forming portion 6b forming a space through which optical fiber F held by ferrule 3 passes. For example, middle housing 6 includes space forming portion 6b and a spring disposition portion 6c located forward of space forming portion 6b. Space forming portion 6b has a plurality of plate-like portions 6d extending in both first direction D1 and direction D3 and arranged in second direction D2. Optical fiber F is passed through the space formed between the pair of plate-like portions 6d arranged in second direction D2 so as to extend in direction D3. For example, when middle housing 6 enters rear housing 7, the end surface of plate-like portion 6d facing first direction D1 gets contacted with an inner side surface 7b of rear housing 7.

Spring disposition portion 6c is a portion in which spring member 8 is disposed. Spring disposition portion 6c protrudes forward from the center of space forming portion 6b in first direction D1, for example. Spring disposition portion 6c has a plate shape extending in both second direction D2 and direction D3. Spring disposition portion 6c has a plurality of protruding portions 6f protruding in first direction D1 and arranged in second direction D2. Spring member 8 is disposed on each end portion side of spring disposition portion 6c in second direction D2 when viewed from protruding portion 6f and between the pair of protruding portions 6f. Spring member 8 is interposed between ferrule 3 and middle housing 6. More specifically, one end of spring member 8 comes into contact with pin keeper 9, and the other end of spring member 8 comes into contact with the front end surface of plate-like portion 6d. Spring member 8 biases toward the front side of pin keeper 9 and ferrule 3 with respect to middle housing 6.

Middle housing 6 is housed in rear housing 7. A part of rear housing 7 is housed in front housing 5. For example, a length of rear housing 7 in direction D3 is longer than a length of rear housing 7 in first direction D1, and the length of rear housing 7 in first direction D1 is longer than a length of rear housing 7 in second direction D2. Rear housing 7 has, for example, an upper surface portion 7c, a lower surface portion 7d, and a pair of side surface portions 7f. Upper surface portion 7c extends in both first direction D1 and direction D3, and lower surface portion 7d faces opposite to upper surface portion 7c. The pair of side surface portions 7f faces first direction D1 and is arranged in first direction D1.

Side surface portion 7f has a protruding portion 7g that protrudes forward with respect to each of upper surface portion 7c and lower surface portion 7d. Side surface portions 7f have a pair of protruding portions 7g arranged in first direction D1. Middle housing 6 is housed between the pair of protruding portions 7g. A spring housing portion 7h is provided on inner side surface 7b of protruding portion 7g. Spring housing portion 7h has a concave shape. Spring member 8 is housed in a space formed between spring housing portion 7h and spring disposition portion 6c of middle housing 6.

Rear housing 7 has a projecting portion 7j to engage with front housing 5. Projecting portion 7j is formed in each of the pair of side surface portions 7f arranged in first direction D1. Side surface portion 7f is a portion to be fitted into engagement hole 5p of front housing 5 from the inner side of front housing 5. For example, the shape of projecting portion 7j when cut along a plane extending in both first direction D1 and direction D3 is a trapezoidal shape. Rear housing 7 is mounted on front housing 5 by engaging projecting portion 7j with engagement hole 5p.

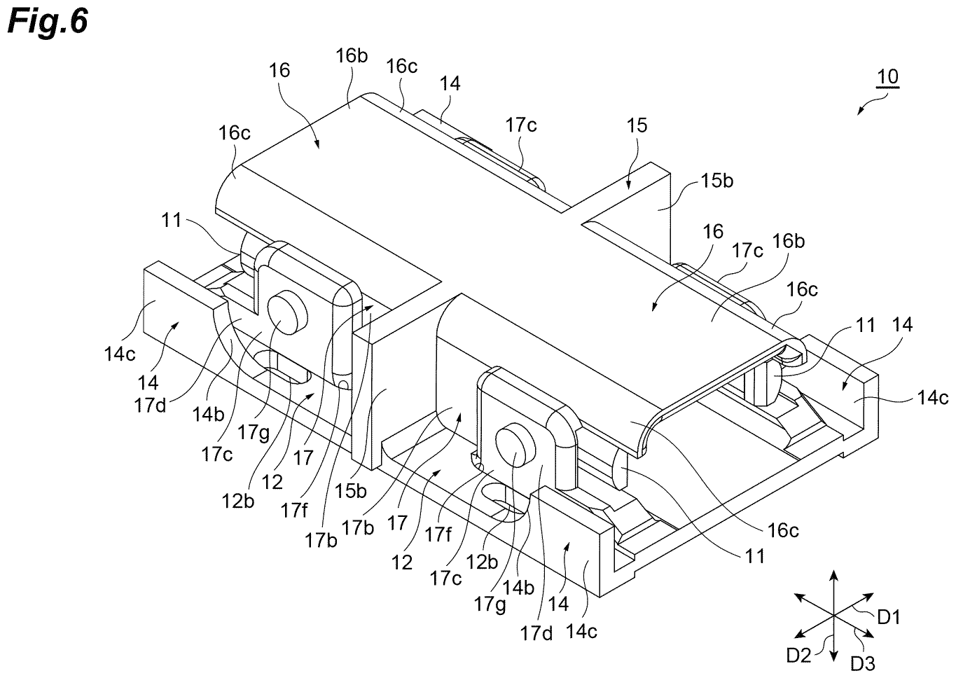

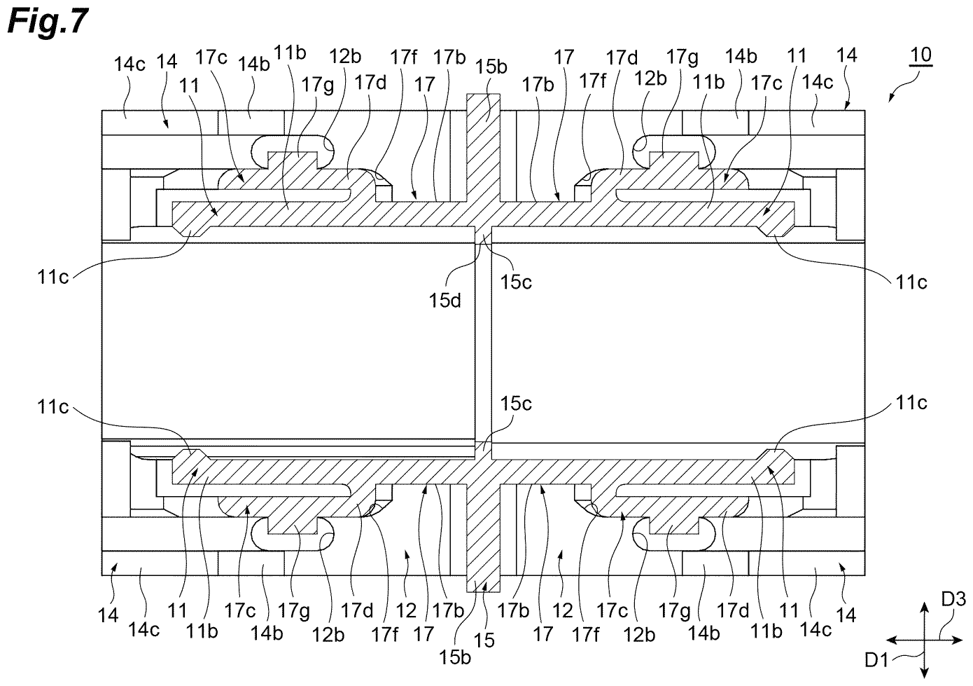

Next, adapter 10 will be described. FIG. 6 is a perspective view showing adapter 10. FIG. 7 is a cross-sectional view showing adapter 10 cut along a plane extending in both first direction D1 and direction D3. As shown in FIG. 6 and FIG. 7, a length of adapter 10 in direction D3 is longer than a length of adapter 10 in first direction D1, and the length of adapter 10 in first direction D1 is longer than a length of adapter 10 in second direction D2.

Adapter 10 includes, for example, a lower plate portion 12, a lever opening prevention portion 14 protruding in direction D3 from an end portion of lower plate portion 12 in first direction D1, and a plate-like portion 15 protruding in direction D3 from the center of lower plate portion 12 in direction D3. Further, adapter 10 includes an upper plate portion 16 opposite to lower plate portion 12 in direction D3, a first wall portion 17 extending from plate-like portion 15 in direction D3, and latch 11 protruding from first wall portion 17 in direction D3.

Lower plate portion 12 extends in both first direction D1 and direction D3. Lower plate portion 12 has a hole 12b facing lever member 20 to be described later. For example, lower plate portion 12 has a rectangular shape when viewed in second direction D2. For example, adapter 10 includes a pair of lever opening prevention portions 14 arranged in first direction D1. Lever opening prevention portion 14 is provided to prevent lever member 20 to be described later from opening toward both end sides in first direction D1. That is, lever member 20 is provided between the pair of lever opening prevention portions 14, and thus lever member 20 is prevented from opening toward both end sides in first direction D1. Lever opening prevention portion 14 has a plate shape extending in both second direction D2 and direction D3. For example, lever opening prevention portion 14 includes a curved plate portion 14b located on the center side in direction D3 and a rectangular plate portion 14c extending in direction D3 on both end sides of curved plate portion 14b in direction D3. The height of curved plate portion 14b with respect to lower plate portion 12 increases toward both end sides of direction D3. The height of rectangular plate portion 14c with respect to lower plate portion 12 is constant.

Plate-like portion 15 includes, for example, a first plate portion 15b that protrudes outward in first direction D1 from first wall portion 17, and a second plate portion 15c that protrudes inward in first direction D1 from first wall portion 17. Plate-like portion 15 includes a pair of first plate portions 15b arranged in first direction D1. The shape of first plate portion 15b viewed in direction D3 is, for example, a rectangular shape. Second plate portion 15c has an opening 15d through which ferrule 3 of optical connector 2 and the ferrule of mating connector 2A pass in direction D3.

Upper plate portion 16 is a portion for housing optical connector 2 connected to adapter 10. For example, when viewed in second direction D2, an area of upper plate portion 16 is smaller than an area of lower plate portion 12. For example, a length of upper plate portion 16 in first direction D1 is shorter than a length of lower plate portion 12 in first direction D1. Upper plate portion 16 has, for example, an upper surface 16b extending in both first direction D1 and second direction D2, and curved surfaces 16c located at both ends of upper surface 16b in first direction D1. As an example, upper surface 16b is a flat surface. Curved surface 16c is curved from the end portion of upper surface 16b in first direction D1 toward lower plate portion 12. As an example, curved surface 16c is curved in an arc shape.

First wall portion 17 includes, for example, an extending portion 17b extending from upper plate portion 16 to lower plate portion 12, and a lever attachment portion 17c to which lever member 20 is attached. Extending portion 17b has, for example, a flat shape extending in both second direction D2 and direction D3. Lever attachment portion 17c protrudes toward both ends in first direction D1 with respect to extending portion 17b. Lever attachment portion 17c includes a plate-like portion 17d having a rectangular shape when viewed in first direction D1, a hole 17f formed in an end portion on the opposite side to upper plate portion 16 when viewed from plate-like portion 17d, and a protrusion 17g protruding from plate-like portion 17d in first direction D1.

For example, the end portion of plate-like portion 17d close to upper plate portion 16 and the end portion of plate-like portion 17d in direction D3 are rounded. Lever member 20 is attached to protrusion 17g so as to be rotatable. As an example, protrusion 17g has a cylindrical shape. Lever member 20 attached to protrusion 17g faces hole 17f. Protrusion 17g and hole 12b are formed, and thus it is possible to reduce hooking of lever member 20 with respect to adapter 10 when lever member 20 rotates. Thus, lever member 20 can be rotated smoothly.

Latch 11 has, for example, an elongated shape extending in direction D3. Latch 11 extends from extending portion 17b toward the end portion of adapter 10 in direction D3. For example, latch 11 has an arm portion 11b extending from extending portion 17b and passing through a center side of lever attachment portion 17c in first direction D1, and a projecting portion 11c to engage with optical connector 2. Projecting portion 11c protrudes toward the center side of first direction D1 at the end portion of arm portion 11b in direction D3. For example, a cross-sectional surface shape of projecting portion tIc cut along a plane extending in both first direction D1 and direction D3 is a trapezoidal shape.

As shown in FIG. 1, projecting portion tIc of latch 11 engages with recessed portion 5k of front housing 5. As described above, the cross-sectional surface shape of recessed portion 5k cut along a plane extending in both first direction D1 and direction D3 is a trapezoidal shape. For example, a length of recessed portion 5k in direction D3 is longer than a length of projecting portion 11c in direction D3. Thus, even in a state where projecting portion 11c is engaged with recessed portion 5k, front housing 5 can be slightly pushed in direction D3 with respect to latch 11.

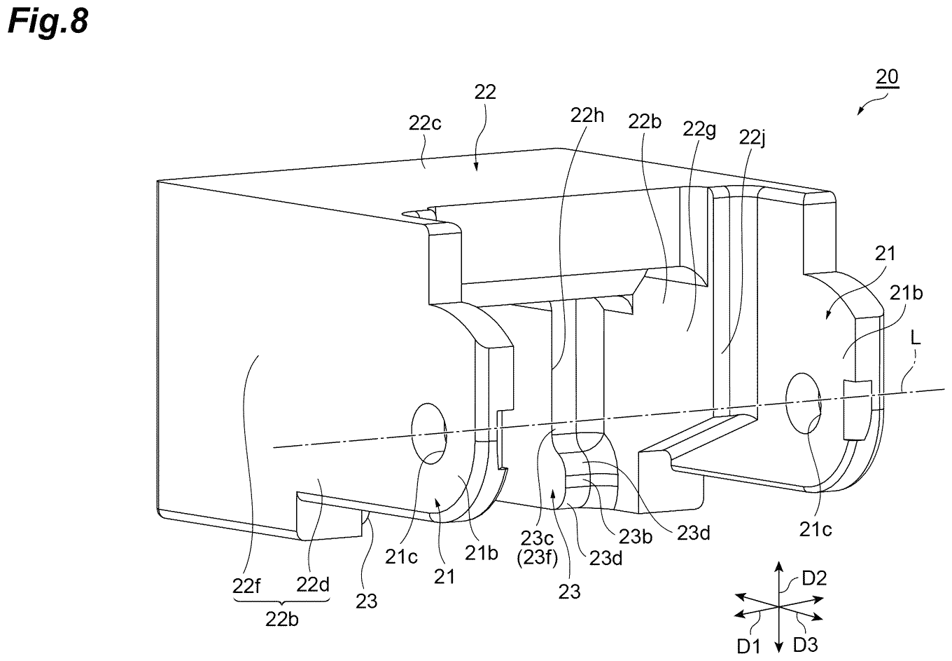

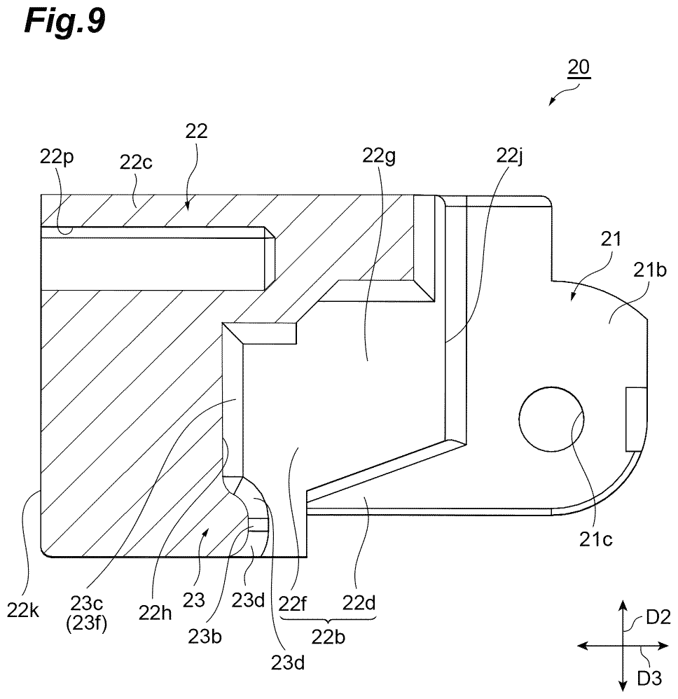

Lever member 20 will be described with reference to FIGS. 2, 8 and 9. FIG. 8 is a perspective view showing lever member 20. FIG. 9 is a cross-sectional view showing lever member 20 cut along a plane extending in both first direction D1 and direction D3. As described above, lever member 20 is attached to adapter 10 so as to be rotatable about central axis L extending in first direction D1. Lever member 20 includes an attachment portion 21 attached to adapter 10 so as to be rotatable and a covering portion 22 that rotates to cover a part of optical connector 2.

Attachment portion 21 has a plate-like portion 21b that protrudes from covering portion 22 and extends in both second direction D2 and direction D3. For example, attachment portion 21 has a hole 21c passing through plate-like portion 21b in first direction D1. As an example, a shape of hole 21c when viewed in first direction D1 is a circular shape, and a diameter (inner diameter) of hole 21c is slightly larger than a diameter (outer diameter) of protrusion 17g of adapter 10. Protrusion 17g is fitted into hole 21c, whereby lever member 20 is attached to adapter 10 so as to be rotatable. Unlike the above example, adapter 10 may have a hole, and lever member 20 may have a protrusion to be fitted into the hole.

For example, the shape of covering portion 22 when viewed from the opposite side to attachment portion 21 in direction D3 is an inverted U-shape. Covering portion 22 has a recessed portion 22p recessed in direction D3 from an end surface 22k facing the opposite side to attachment portion 21. The shape of recessed portion 22p when viewed in direction D3 is, for example, an inverted U-shape. Covering portion 22 includes a pair of second wall portions 22b extending in both second direction D2 and direction D3 and arranged in first direction D1, and an upper surface portion 22c connecting the pair of second wall portions 22b to each other.

Lever member 20 is attached to adapter 10 in a state in which each second wall portion 22b is positioned on both end sides in first direction D1 with respect to each first wall portion 17 of adapter 10. Second wall portion 22b includes, for example, a first plate portion 22d contiguous with attachment portion 21 and a second plate portion 22f extending from first plate portion 22d to the opposite side to attachment portion 21. For example, the length of first plate portion 22d in second direction D2 is longer than the length of attachment portion 21 in second direction D2, and the length of second plate portion 22f in second direction D2 is longer than the length of first plate portion 22d in second direction D2. For example, upper surface portion 22c is a portion to be pressed downward with fingers or the like. Lever member is swung downward by being pressed upper surface portion 22c with fingers or the like, and thus optical connector 2 can be connected to adapter 10.

Lever member 20 includes a latch pressing member 22g to press latch 11 of adapter 10 from both end sides in first direction D1. As shown in FIGS. 1, 8 and 9, latch pressing member 22g is, for example, an inner portion of second wall portion 22b. Latch pressing member 22g presses latch 11 from both end sides in first direction D1 to prevent latch 11 from opening toward both end sides in first direction D1.

Lever member 20 has a transfer mechanism 23 configured to transfer optical connector 2 in direction D3 by rotating around central axis L toward optical connector 2. As shown in FIGS. 2, 8, and 9, lever member 20 has a plurality of (two, for example) transfer mechanisms 23 arranged in first direction D1. Transfer mechanism 23 is provided, for example, in an inner side of second wall portion 22b in first direction D1. Transfer mechanism 23 has a projecting portion 23b that comes in contact with optical connector 2 and a retraction portion 23c into which optical connector 2 enters.

Projecting portion 23b comes into contact with protruding portion 5j of front housing 5. For example, a first step portion 22h is formed in inner side of second wall portion 22b in first direction D1, and projecting portion 23b is formed at an end portion of first step portion 22h opposite to upper surface portion 22c. First step portion 22h extends in second direction D2. The thickness of second wall portion 22b on attachment portion 21 side of first step portion 22h is thinner than the thickness of second wall portion 22b on the side opposite to attachment portion 21 of first step portion 22h. Projecting portion 23b corresponds to a portion of first step portion 22h that protrudes toward attachment portion 21. For example, projecting portion 23b has a curved surface 23d that protrudes toward attachment portion 21 as curved surface 23d approaches the center of projecting portion 23b in second direction D2. Curved surface 23d is a curved surface that comes in contact with protruding portion 5j of front housing 5. For example, curved surface 23d has an arc shape.

Retraction portion 23c extends from projecting portion 23b toward upper surface portion 22c. Retraction portion 23c is a portion into which protruding portion 5j of front housing 5 that has passed over projecting portion 23b toward upper surface portion 22c enters. Retraction portion 23c is a portion formed on upper surface portion 22c close to projecting portion 23b and corresponds to a portion recessed on the opposite side to attachment portion 21 with respect to projecting portion 23b. For example, retraction portion 23c has a side surface 23f extending in both first direction D1 and second direction D2. As an example, side surface 23f is formed in a flat shape.

For example, a second step portion 22j is formed between first step portion 22h and attachment portion 21. The thickness of second wall portion 22b close to attachment portion 21 with respect to second step portion 22j is thinner than the thickness of second wall portion 22b opposite to attachment portion 21 with respect to second step portion 22j. In this manner, in lever member 20, the thickness of second wall portion 22b becomes thinner as it approaches attachment portion 21. Thus, lever member 20 can be rotated more smoothly with respect to adapter 10 to which attachment portion 21 is attached.

Next, an example of steps of an optical connection method according to an embodiment will be described. First, as shown in FIG. 2, optical connector 2 is disposed so that ferrule 3 faces lever member 20 attached to adapter 10 (disposing an optical connector). Then, lever member 20 is rotated upward about central axis L (rotating a lever member upward).

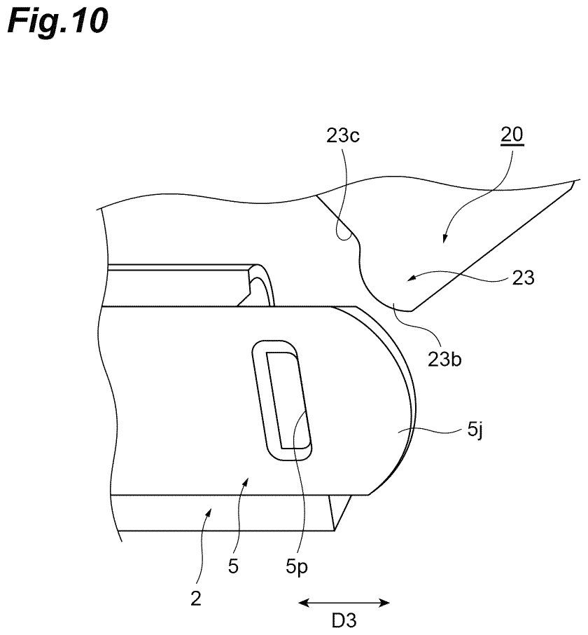

Next, optical connector 2 is placed on lower plate portion 12 of adapter 10, and as shown in FIG. 10, protruding portion 5j of front housing 5 is opposite to projecting portion 23b of transfer mechanism 23 (making a protruding portion opposite to a projecting portion). At this time, optical connector 2 is disposed so that projecting portion 23b is positioned obliquely above protruding portion 5j. In the state of FIG. 10, an inclination angle of lever member 20 with respect to direction D3 is 36.74 degrees as an example.

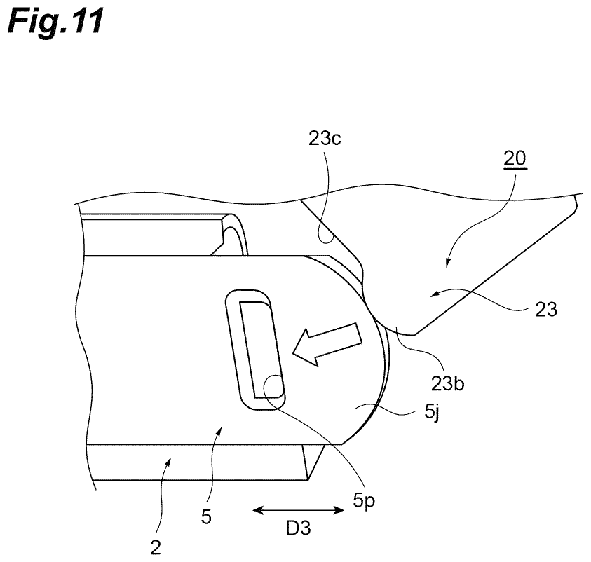

In the state shown in FIG. 10, lever member 20 is rotated about central axis L toward optical connector 2, and thus lever member 20 is lowered to bring projecting portion 23b into contact with protruding portion 5j (bringing the projecting portion into contact). As shown in FIG. 11, when lever member 20 is further lowered, protruding portion 5j is pushed forward, and optical connector 2 is transferred forward.

When optical connector 2 is transferred forward, as shown in FIGS. 1 and 11, front housing 5 pushes latch 11 to spread to both end sides of first direction D1, and then latch 11 engages with recessed portion 5k (engaging the optical connector). At this time, latch pressing member 22g reaches latch 11. Then, lever member 20 is entered into between the pair of lever opening prevention portions 14 of adapter 10. At this time, an inclination angle of lever member 20 with respect to direction D3 is 24.6 degrees as an example.

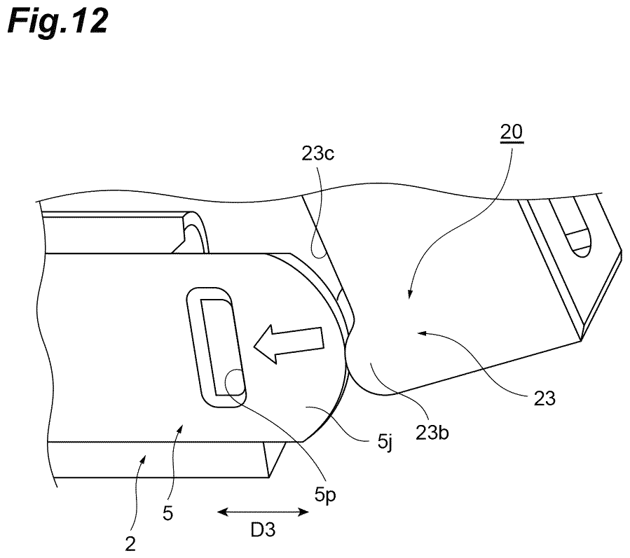

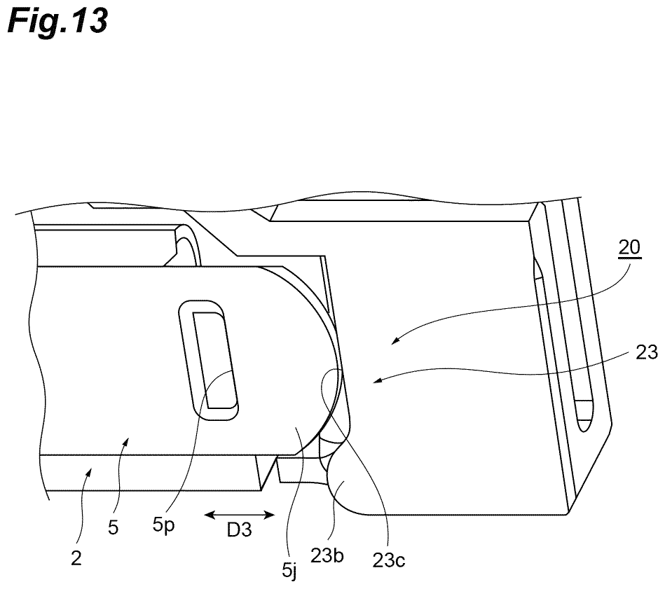

When lever member 20 is lowered from the above state, optical connector 2 is further pushed forward as shown in FIG. 12 (further pushing the optical connector). At this time, a pushing length of optical connector 2 in direction D3 is, for example, 0.3 mm. As shown in FIG. 13, when lever member 20 is further lowered, protruding portion 5j passes over projecting portion 23b to enter into retraction portion 23c (the projecting portion entering into the retraction portion). The connection of optical connector 2 to adapter 10 is completed through the above steps. In this state, retraction portion 23c and protruding portion 5j are not in contact with each other, and there is a gap between retraction portion 23c and protruding portion 5j.

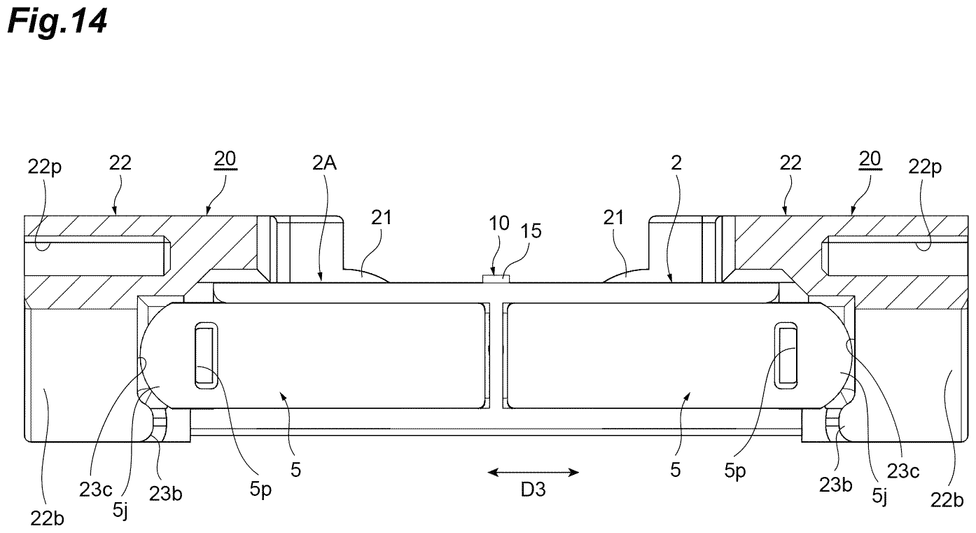

As shown in FIG. 14, for example, mating connector 2A is connected to adapter 10 through the same steps as described above. At this time, each guiding pin P is inserted into each guiding hole 3c, and the optical connection of optical connector 2 to mating connector 2A is realized. For example, optical fiber F held in ferrule 3 of optical connector 2 is PC-connected to the optical fiber held in the ferrule of mating connector 2A. Then, a positional relationship between recessed portion 5k of optical connector 2 and latch 11 of adapter 10 is determined by a spring-back operation of spring member 8 of optical connector 2.

Next, a method of disconnecting optical connector 2 from adapter 10 will be described. First, lever member 20 is rotated upward about central axis L to retract latch pressing member 22g from latch 11 (retracting a latch pressing member). At this time, when mating connector 2A is connected to adapter 10, recessed portion 5k of optical connector 2 is transferred backward from latch 11 by a repulsive force of spring member 8, and thus optical connector 2 is removed from adapter 10 (removing the optical connector). In this state, since guiding pin P is inserted into guiding hole 3c, optical connector 2 is prevented from falling off from adapter 10 by a frictional force of guiding pin P. When mating connector 2A is not connected to adapter 10, the repulsive force of spring member 8 is not generated, but optical connector 2 is held with fingers and pulled in direction D3 to release the engagement of latch 11 with recessed portion 5k.

Next, the effect obtained from optical connection component 1 and the optical connection method according to the embodiment will be described. In optical connection component 1 and the optical connection method according to the embodiment, optical connector 2 includes ferrule 3 holding optical fiber F, and optical connector 2 is connected to adapter 10. Adapter 10 includes lever member 20 having transfer mechanism 23 configured to transfer optical connector 2 in direction D3, which is the optical axis direction. Adapter 10, not optical connector 2, has lever member 20, so that optical connector 2 can be miniaturized and an insertion resistance of optical connector 2 into adapter 10 can be reduced to facilitate the insertion. As a result, an operation force required for the operation of connecting optical connector 2 to adapter can be reduced.

As a specific example, when a load for pushing optical connector 2 into adapter 10 is P (N), a pushing amount is d (mm), a rotation angle of lever member 20 when optical connector 2 is pushed in by 1 mm is Δθ (rad), and a length of lever member 20 from central axis L is L, an operation force F (N) of lever member 20 is expressed by the following equation (1) using a relationship of work. F=P×d/(L×Δθ) (1) In the above equation (1), when P is equal to 60, d is equal to 1, Δθ is equal to 8, and L is equal to 24, the value of F is 18. Thus, optical connector 2 is pushed by the operation of lever member 20, and thus the operation force is reduced. Further, by increasing a length (L) of lever member 20 from central axis L, the operating force can be further reduced.

Optical connection component 1 includes lever member 20 attached to adapter 10 so as to be rotatable. Lever member 20 has transfer mechanism 23 configured to transfer optical connector 2 in direction D3 by rotating toward optical connector 2. Thus, optical connector 2 can be transferred in direction D3 by the rotation of lever member 20, and optical connector 2 can be engaged with latch 11. Thus, optical connector 2 can be easily connected. That is, since optical connector 2 can be pushed in by the rotation operation of lever member without the need to push optical connector 2 into adapter 10 with fingers, optical connector 2 can be easily connected.

Lever member 20 may have latch pressing member 22g configured to press latch 11 with optical connector 2 engaged. In this case, latch pressing member 22g presses latch 11 of adapter 10, and thus it is possible to suppress the opening of latch 11 with optical connector 2 engaged. Thus, optical connector 2 can be firmly engaged with latch 11 of adapter 10. Since the opening of latch 11 can be suppressed, a positional deviation of optical connector 2 with respect to adapter 10 can be suppressed.

Transfer mechanism 23 may have projecting portion 23b configured to transfer optical connector 2 in direction D3 in a state of being in contact with optical connector 2. In this case, transfer mechanism 23 has projecting portion 23b, and thus the configuration of transfer mechanism 23 configured to transfer optical connector 2 can be simplified. Optical connector 2 can be pushed toward adapter 10 by lever member 20 rotating in a state in which projecting portion 23b is in contact with optical connector 2. Thus, lever member 20 is rotated, and optical connector 2 can be pushed toward adapter 10 by projecting portion 23b, so that optical connector 2 can be easily connected to adapter 10.

Optical connector 2 may have protruding portion 5j protruding in a direction opposite to a direction in which transfer mechanism 23 transfers optical connector 2. Transfer mechanism 23 may transfer optical connector 2 by lever member 20 rotating in a state in which projecting portion 23b is in contact with protruding portion 5j. In this case, optical connector 2 can be transferred by lever member 20 rotating in a state in which projecting portion 23b is in contact with protruding portion 5j of optical connector 2.

Optical connector 2 may include the plurality of ferrules 3, and housing unit 4 housing the plurality of ferrules 3. In this case, housing unit 4 houses the plurality of ferrules 3, and thus the plurality of ferrules 3 of optical connector 2 can be collectively optically connected.

In housing unit 4, the plurality of ferrules 3 may be arranged in first direction D1, and may be arranged in second direction D2. In this case, the plurality of ferrules 3 arranged in first direction D1 and second direction D2 can be collectively optically connected.

Each of the plurality of ferrules 3 may have end surface 3b that faces mating connector 2A to which optical connector 2 is optically connected via adapter 10. The plurality of ferrule 3 may be disposed so that the plurality of end surfaces 3b are arranged on virtual inclined surface S inclined with respect to second direction D2 when viewed in first direction D1. In this case, since each of the plurality of end surfaces 3b is inclined with respect to second direction D2, it is possible to suppress the reflected return light from each end surface 3b. The plurality of ferrules 3 are disposed such that the plurality of end surfaces 3b are arranged along virtual inclined surface S inclined with respect to second direction D2. Thus, a cleaning tool can be moved along the plurality of end surfaces 3b to clean the plurality of end surfaces 3b, and thus end surfaces 3b of ferrule 3 can be easily cleaned.

Housing unit 4 may include front housing 5 having recessed portion 5k with which latch 11 engages. In this case, latch 11 of adapter can be engaged with recessed portion 5k formed in front housing 5 of optical connector 2. Front housing 5 may have a rectangular parallelepiped shape. In this case, front housing 5 can be formed in a simple shape, which contributes to further miniaturization of optical connector 2. Further, ferrule 3 may be housed in front housing 5.

Housing unit 4 may include middle housing 6 including space forming portion 6b forming a space through which optical fiber F held by ferrule 3 passes. In this case, optical fiber F extending from ferrule 3 can be passed through the space formed by space forming portion 6b of middle housing 6. Optical connector 2 may include spring member 8 interposed between ferrule 3 and middle housing 6. In this case, ferrule 3 can be biased by spring member 8. Housing unit 4 may include rear housing 7 housing middle housing 6.

Lever member 20 may have the plurality of transfer mechanisms 23 arranged in first direction D1. In this case, the plurality of transfer mechanisms 23 transfer optical connector 2 in direction D3. Thus, since optical connector 2 can be transferred more smoothly, optical connector 2 can be connected to adapter 10 more easily.

Optical connector 2 may pass over projecting portion 23b when engaging with latch 11 as a result of rotation of lever member 20. Transfer mechanism 23 may has retraction portion 23c into which optical connector 2 having passed over projecting portion 23b enters. In this case, optical connector 2 having passed over projecting portion 23b can be retracted to retraction portion 23c. Further, it is possible to prevent latch 11 from interfering with the positioning of optical connector 2.

Adapter 10 may have protrusion 17g protruding in first direction D1, and lever member 20 may have hole 21c. Lever member 20 may be rotatable with respect to adapter 10 in a state in which protrusion 17g is fitted into hole 21c. In this case, an attachment structure of lever member 20 to adapter 10 can be simplified. Even when adapter 10 has a hole and first wall portion 17 has a protrusion to fit into the hole, the same effect as described above can be obtained.

Adapter 10 may have a pair of first wall portions 17 arranged in first direction D1. Lever member 20 may have the pair of second wall portions 22b arranged in first direction D1. Lever member 20 may be attached to adapter 10 in a state in which second wall portion 22b is positioned on both end sides in first direction D1 with respect to first wall portion 17. In this case, each second wall portion 22b of lever member 20 is positioned on both end sides in first direction D1 with respect to first wall portion 17 of adapter 10. Thus, since lever member is disposed so as to sandwich adapter 10 from first direction D1, the rotation of lever member 20 with respect to adapter 10 can be stabilized. Thus, optical connector 2 can be connected to adapter 10 more easily.

Lever member 20 may have upper surface portion 22c connecting the pair of second wall portions 22b to each other. In this case, lever member 20 can be pushed down toward optical connector 2 and rotated by upper surface portion 22c being pushed, and thus optical connector 2 can be more easily connected to adapter 10. Adapter 10 may include lever opening prevention portion 14 located close to each of both end sides of lever member 20 in first direction D1. In this case, lever opening prevention portion 14 can suppress the opening of lever member 20.

The embodiments of the optical connection component and the optical connection method according to the present disclosure have been described above. However, the optical connection component and the optical connection method according to the present disclosure are not limited to the above-described embodiments, and can be appropriately modified within the scope of the gist described in the claims. For example, in the above-described embodiment, the example in which protruding portion 5j of optical connector 2 with which projecting portion 23b of transfer mechanism 23 is in contact is arc-shaped has been described. However, the shape of the protruding portion may not be arc-shaped. The protruding portion may have, for example, a triangular shape or the like, and may have any shape as long as it protrudes backward with respect to the rotation trajectory of lever member 20.

### REFERENCE SIGNS LIST

1 optical connection component
2 optical connector
2A mating connector
3 ferrule
3b end surface
3c guiding hole
3d optical fiber holding hole
4 housing unit
5 front housing
5b upper surface portion
5c lower surface portion
5d side surface portion
5f first opening
5 g second opening
5h end edge
5j protruding portion
5k recessed portion
5p engagement hole
6 middle housing
6b space forming portion
6c spring disposition portion
6d plate-like portion
6f protruding portion
7 rear housing
7b inner side surface
7c upper surface portion
7d lower surface portion
7f side surface portion
7g protruding portion
7h spring housing portion
7j projecting portion
8 spring member
9 pin keeper
10 adapter
11 latch
11b arm portion
11c projecting portion
12 lower plate portion
12b hole
14 lever opening prevention portion
14b curved plate portion
14c rectangular plate portion
15 plate-like portion
15b first plate portion
15c second plate portion
15d opening
16 upper plate portion
16b upper surface
16c curved surface
17 first wall portion
17b extending portion
17c lever attachment portion
17d plate-like portion
17f hole
17g protrusion
20 lever member
21 attachment portion
21b plate-like portion
21c hole
22 covering portion
22b second wall portion
22c upper surface portion
22d first plate portion
22f second plate portion
22g latch pressing member
22h first step portion
22j second step portion
22k end surface
22p recessed portion
23 transfer mechanism
23b projecting portion
23c retraction portion
23d curved surface
23f side surface
D1 first direction
D2 second direction
D3 direction
F optical fiber
L central axis
P guiding pin
S inclined surface

1. An optical connection component comprising:
an adapter to which an optical connector including a ferrule holding an optical fiber is connected; and
a lever member attached to the adapter so as to be rotatable about a central axis extending in a first direction intersecting an optical axis direction of the optical fiber,
wherein the adapter has a latch with which the optical connector transferring in the optical axis direction engages, and
wherein the lever member has a transfer mechanism configured to transfer the optical connector in the optical axis direction by rotating about the central axis toward the optical connector.

2. The optical connection component according to claim 1, wherein the lever member has a latch pressing member configured to press the latch with the optical connector engaged.

3. The optical connection component according to claim 1, wherein the transfer mechanism has a projecting portion configured to transfer the optical connector in the optical axis direction in a state of being in contact with the optical connector.

4. The optical connection component according to claim 3,
wherein the optical connector has a protruding portion protruding in a direction opposite to a direction in which the transfer mechanism transfers the optical connector, and
wherein the transfer mechanism transfers the optical connector by the lever member rotating in a state in which the projecting portion is in contact with the protruding portion.

5. The optical connection component according to claim 1, wherein the optical connector includes a plurality of the ferrules, and a housing unit housing the plurality of ferrules.

6. The optical connection component according to claim 5, wherein, in the housing unit, the plurality of ferrules are arranged in the first direction, and are arranged in a second direction intersecting both the optical axis direction and the first direction.

7. The optical connection component according to claim 6,
wherein each of the plurality of ferrules has an end surface that faces a mating connector to which the optical connector is optically connected via the adapter, and
wherein the plurality of ferrules are disposed so that a plurality of the end surfaces are arranged on a virtual inclined surface inclined with respect to the second direction when viewed in the first direction.

8. The optical connection component according to claim 5, wherein the housing unit includes a front housing having a recessed portion with which the latch engages.

9. The optical connection component according to claim 8, wherein the front housing has a rectangular parallelepiped shape.

10. The optical connection component according to claim 8, wherein the ferrule is housed in the front housing.

11. The optical connection component according to claim 5, wherein the housing unit includes a middle housing including a space forming portion forming a space through which the optical fiber held by the ferrule passes.

12. The optical connection component according to claim 11, wherein the optical connector includes a spring member interposed between the ferrule and the middle housing.

13. The optical connection component according to claim 11, wherein the housing unit includes a rear housing housing the middle housing.

14. The optical connection component according to claim 1, wherein the lever member has a plurality of the transfer mechanisms arranged in the first direction.

15. The optical connection component according to claim 3,
wherein the optical connector passes over the projecting portion when engaging with the latch as a result of rotation of the lever member, and
wherein the transfer mechanism has a retraction portion into which the optical connector having passed over the projecting portion enters.

16. The optical connection component according to claim 1,
wherein the adapter has a protrusion protruding in the first direction,
wherein the lever member has a hole depressed in the first direction, and
wherein the lever member is rotatable with respect to the adapter in a state in which the protrusion is fitted into the hole.

17. The optical connection component according to claim 1,
wherein the adapter has a pair of first wall portions arranged in the first direction,
wherein the lever member has a pair of second wall portions arranged in the first direction, and
wherein the lever member is attached to the adapter in a state in which the second wall portions are positioned on both end sides in the first direction with respect to the first wall portions.

18. The optical connection component according to claim 17,
wherein the adapter has protrusions protruding from the first wall portions toward both the end sides in the first direction,
wherein the lever member has holes into which the protrusions are inserted, and
wherein the lever member is rotatable with respect to the adapter in a state in which the protrusions are fitted into the holes.

19. The optical connection component according to claim 17, wherein the lever member has an upper surface portion connecting the pair of second wall portions to each other.

20. The optical connection component according to claim 1, wherein the adapter includes a lever opening prevention portion located on each of both end sides in the first direction of the lever member.

21. An optical connection method of optically connecting an optical connector including an optical fiber to a mating connector via an adapter, the method comprising:
preparing a lever member attached to the adapter so as to be rotatable about a central axis extending in a first direction intersecting an optical axis direction of the optical fiber;
by rotating the lever member about the central axis toward the optical connector, transferring the optical connector in the optical axis direction and engaging the optical connector with a latch of the adapter.

22. The optical connection component according to claim 1,
wherein the lever member has a protrusion protruding in the first direction,
wherein the adapter has a hole depressed in the first direction, and
wherein the lever member is rotatable with respect to the adapter in a state in which the protrusion is fitted into the hole.
